(19) United States
(12) Patent Application Publication
(10) Pub. No.: US 2025/0306293 A1
(43) Pub. Date: Oct. 2, 2025

(54) OPTICAL CONNECTOR, OPTICAL CONNECTOR ASSEMBLY, AND OPTICAL CONNECTING STRUCTURE

(71) Applicant: Fujikura Ltd., Tokyo (JP)

(72) Inventor: Shuhei Kanno, Sakura-shi (JP)

(73) Assignee: Fujikura Ltd., Tokyo (JP)

(21) Appl. No.: 18/855,769

(22) PCT Filed: Feb. 9, 2023
(86) PCT No.: PCT/JP2023/004306

§ 371 Date: Oct. 10, 2024

(30) Foreign Application Priority Data
Jun. 3, 2022 (JP) 2022-090844

(51) Int. Cl. G02B 6/38

(52) U.S. Cl. CPC G02B 6/3869; G02B 6/3825

(57) ABSTRACT

An optical connector includes a ferrule including a connection end surface having a fiber hole through which an optical fiber is inserted, a holding member that holds the ferrule, a spring push, and a biasing member that biases the ferrule, one end of the biasing member contacting the holding member and the other end of the biasing member contacting the spring push. The holding member includes an engaging portion. The spring push includes an engaged portion that engages the engaging portion.

### CROSS-REFERENCE TO RELATED APPLICATIONS

The present application is a national phase application of International Application No. PCT/JP2023/004306, filed Feb. 9, 2023, which claims priority to Japanese Patent Application No. 2022-090844, filed Jun. 3, 2022. The contents of these applications are incorporated herein by reference in their entirety.

### BACKGROUND

### Technical Field

The present invention relates to an optical connector, an optical connector assembly, and an optical connecting structure.

### Discussion of the Background

In order to facilitate the construction of optical networks, optical connectors for optical fibers are widely used. In addition, as the density of the optical network increases, there is a demand for increasing the arrangement density of the optical fibers. In order to increase the arrangement density of the optical fibers, for example, an optical connector that is capable of connecting a large number of optical fibers collectively, such as a multi-fiber push on (MPO) connector (see Patent Document 1), is used. In such a connection of the optical connector, a method of pressing connection end surfaces of ferrules provided in the optical connector against each other is used.

In order to maintain the connection between the ferrules, the optical connector generally has a so-called floating structure. The floating structure of the optical connector includes, for example, a ferrule, a biasing member such as a spring, a spring push, and a housing in which these three components are accommodated. The biasing member is disposed between the ferrule and the spring push and biases the ferrule. The ferrule is maintained in a floating state, allowing the ferrule to move forward and rearward in the connection direction due to the biasing force of the biasing member. The housing serves to maintain the positional relationship among the three components and maintain the biasing force of the biasing member.

### PATENT DOCUMENT

Patent Document 1: Japanese Patent Publication No. 2019-132929

In the optical connector with the above-described structure, since the housing accommodates the three components, it is difficult to set the dimension (length) for arranging a plurality of optical connectors to be an interval shorter than the dimension of the housing. That is, the presence of the housing has created an upper limit on the arrangement density of the optical fibers. Therefore, in order to further improve the arrangement density of the optical fibers, an optical connector without a housing has been desired.

### SUMMARY

One or more embodiments provide an optical connector, an optical connector assembly, and an optical connecting structure in which the positional relationship among a ferrule, a biasing member, and a spring push can be maintained even without a housing.

Aspect 1 of one or more embodiments is an optical connector including a ferrule including a connection end surface where a fiber hole through which an optical fiber is inserted is open, a holding member that holds the ferrule, a spring push, and a biasing member that biases the ferrule by abutting one end to the holding member and abutting the other end to the spring push, in which the holding member includes an engaging portion, and the spring push includes an engaged portion that engages with the engaging portion.

In addition, Aspect 2 of one or more embodiments is the optical connector according to Aspect 1, in which the holding member includes an extending portion that extends toward the spring push and penetrates the biasing member, and the engaging portion is provided on the extending portion.

In addition, Aspect 3 of one or more embodiments is the optical connector according to Aspect 1 or 2, in which the engaged portion is a hole into which at least part of the engaging portion is inserted, and the engaging portion and the engaged portion are engaged with each other to restrict the holding member from falling off from the spring push due to a biasing force of the biasing member and to allow the holding member and the spring push to approach each other.

In addition, Aspect 4 of one or more embodiments is the optical connector according to any one of Aspects 1 to 3, further including a release member that covers at least part of the spring push from an outer side in a radial direction, in which the spring push includes an engaging claw that engages with an adapter, and when the release member is pulled rearward, the release member bends the engaging claw toward an inner side in the radial direction to release the engagement between the engaging claw and the adapter, when a direction from the ferrule to the spring push is referred to as rearward.

In addition, Aspect 5 of one or more embodiments is the optical connector according to Aspect 4, in which the release member includes a first member and a second member that are connected to each other to interpose at least part of the spring push in the radial direction.

In addition, Aspect 6 of one or more embodiments is the optical connector according to Aspect 4 or 5, further including a restricting portion that restricts the release member from falling off rearward from the spring push.

In addition, Aspect 7 of one or more embodiments is an optical connector assembly including a plurality of the optical connectors according to any one of Aspects 4 to 6, and the adapter into which the plurality of optical connectors is inserted, in which the adapter includes a plurality of engaging holes with which a plurality of the engaging claws are engaged.

In addition, Aspect 8 of one or more embodiments is an optical connecting structure including the optical connector assembly according to Aspect 7, and a receptacle including a main body portion and a rotating portion attached to the main body portion, in which the rotating portion is attached to the main body portion such that the rotating portion is switchable between a fixed state in which the optical connector assembly is fixed to the main body portion and a non-fixed state in which the optical connector assembly is allowed to be removed from the main body portion by a rotational movement, the adapter includes a protruding portion that protrudes from an outer peripheral surface of the adapter, and the rotating portion is provided with a convex curved surface that gradually presses the protruding portion forward as the rotating portion is switched from the non-fixed state to the fixed state by the rotational movement.

According to one or more embodiments, it is possible to provide an optical connector, an optical connector assembly, and an optical connecting structure in which the positional relationship among a ferrule, a biasing member, and a spring push can be maintained even without a housing.

### BRIEF DESCRIPTION OF THE DRAWINGS

FIG. 1 is an exploded perspective view showing an optical connecting structure according to one or more embodiments.

FIG. 2 is an exploded perspective view showing an optical connector according to one or more embodiments.

FIG. 3 is a cross-sectional view taken along the line III-III shown in FIG. 2.

FIG. 4 is a perspective view showing a ferrule according to one or more embodiments.

FIG. 5 is a perspective view showing a holding member according to one or more embodiments.

FIG. 6 is a perspective view showing a spring push according to one or more embodiments.

FIG. 7 is a diagram for describing a release member according to one or more embodiments.

FIG. 8 is an enlarged view showing the release member according to one or more embodiments.

FIG. 9 is a perspective view showing an adapter according to one or more embodiments.

FIG. 10 is a cross-sectional view taken along the line X-X shown in FIG. 1.

FIG. 11 is a cross-sectional view taken along the line XI-XI shown in FIG. 1.

FIG. 12 is a cross-sectional view taken along the line XII-XII shown in FIG. 1.

FIG. 13 is a diagram of a receptacle shown in FIG. 12 as viewed from the arrow XIII.

FIG. 14A is a diagram showing a rotating portion in a fixed state.

FIG. 14B is a diagram showing the rotating portion in a non-fixed state.

FIG. 15 is a perspective view showing the rotating portion according to one or more embodiments.

FIG. 16A is a cross-sectional view taken along the line XVIA-XVIA shown in FIG. 12, showing a state in which an optical connector assembly is being inserted into the receptacle.

FIG. 16B is a diagram showing a state subsequent to FIG. 16A.

FIG. 16C is a diagram showing a state subsequent to FIG. 16B.

### DESCRIPTION OF THE EMBODIMENTS

Hereinafter, an optical connector 1, an optical connector assembly 2, and an optical connecting structure 100 according to one or more embodiments will be described with reference to the drawings.

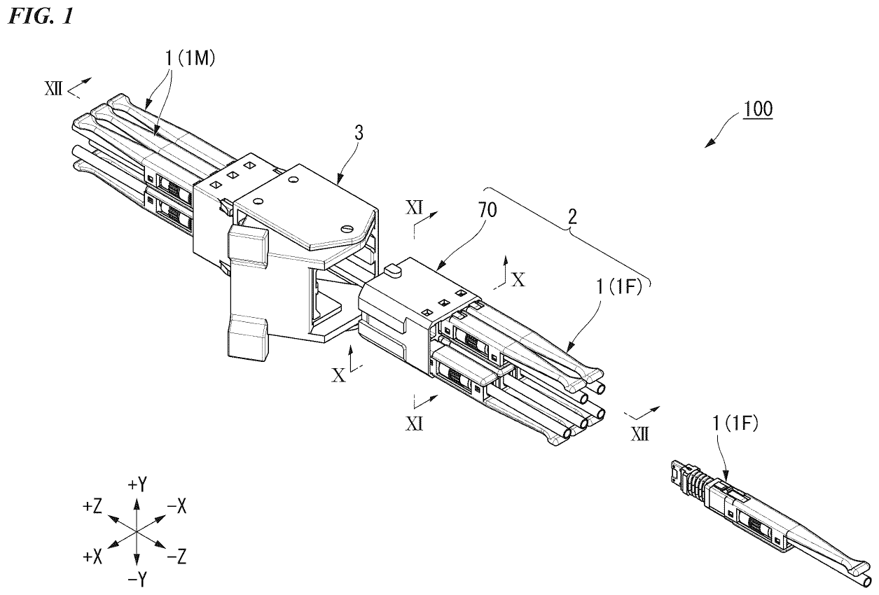

As shown in FIG. 1, the optical connecting structure 100 according to one or more embodiments includes a receptacle 3 and a plurality of the optical connectors 1. In one or more embodiments, the plurality of optical connectors 1 includes a plurality (six in the shown example) of male connectors 1M and a plurality (six in the shown example) of female connectors 1F. The plurality of female connectors 1F are inserted into an adapter 70. In one or more embodiments, the plurality of female connectors 1F and the adapter 70 may be collectively referred to as the optical connector assembly 2.

In one or more embodiments, the configuration of the male connector 1M and the configuration of the female connector 1F are basically the same, except for a length of a guide pin 25 (details will be described below). Therefore, the description of the male connector 1M will be omitted, and only the female connector 1F will be described. In addition, in the following description, the female connector 1F is simply referred to as “optical connector 1”, and unless otherwise specified, “optical connector 1” refers to the female connector 1F.

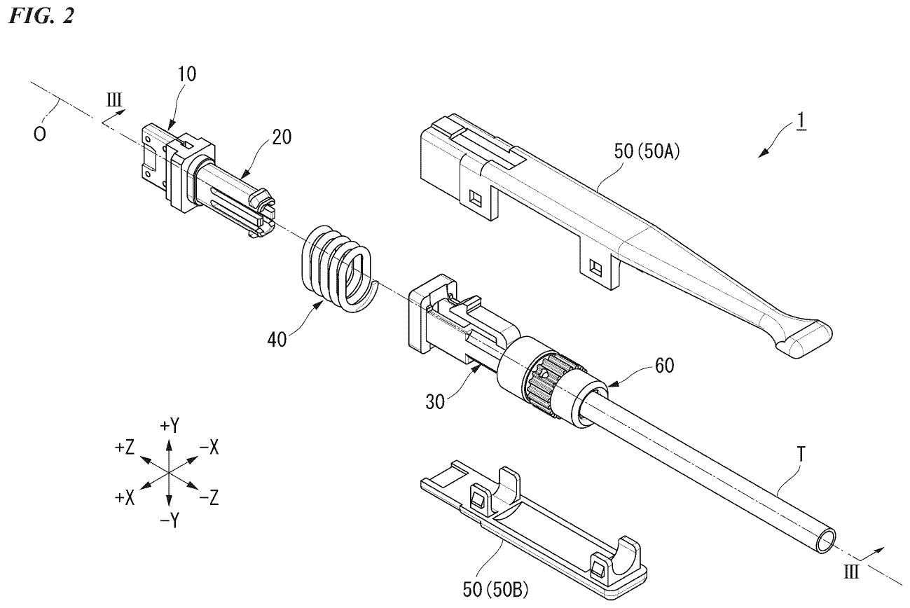

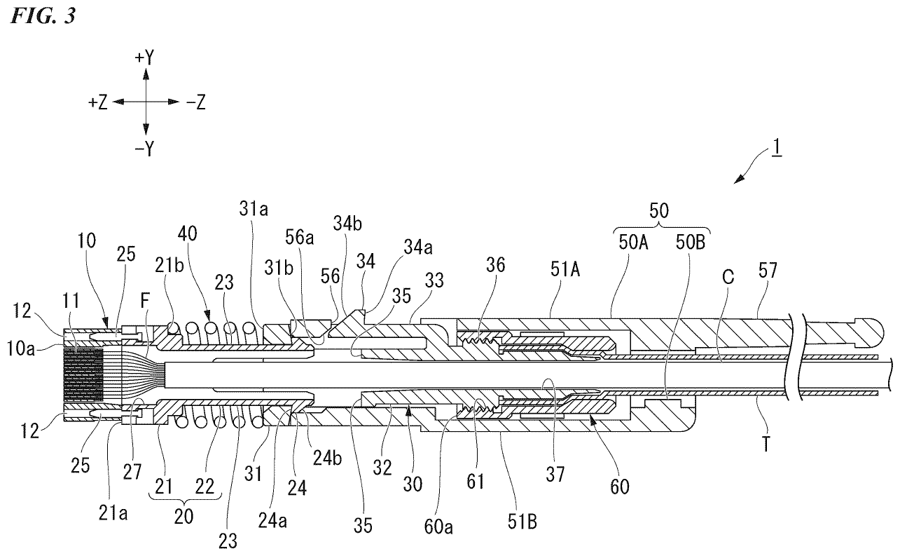

As shown in FIGS. 2 and 3, the optical connector 1 includes a ferrule 10, a holding member 20, a spring push 30, and a biasing member 40. As shown in FIG. 3, the ferrule 10 bas a connection end surface 10a where a plurality of fiber holes 11 are open. An optical fiber F is inserted through each of the fiber boles 11. The optical connector 1 may include a release member 50 and a restricting member (restricting portion) 60.

### Definition of Direction

Here, in one or more embodiments, the longitudinal direction of the fiber hole 11 is simply referred to as a longitudinal direction Z. One direction orthogonal to the longitudinal direction Z is referred to as a first direction X. A direction orthogonal to both the longitudinal direction Z and the first direction X is referred to as a second direction Y. A direction from the spring push 30 to the ferrule 10 along the longitudinal direction Z is referred to as a +Z direction, forward, or a distal end side. A direction opposite to the +Z direction is referred to as a −Z direction, rearward, or a base end side. One direction along the first direction X is referred to as a +X direction or a front side. A direction opposite to the +X direction is referred to as a −X direction or a rear side. One direction along the second direction Y is referred to as a +Y direction or upward. A direction opposite to the +Y direction is referred to as a −Y direction or downward. In addition, a direction intersecting a central axis O of the optical connector 1 when viewed from the longitudinal direction Z is referred to as a radial direction. Along the radial direction, a direction closer to the central axis O is referred to as an inner side in the radial direction, and a direction separated from the central axis O is referred to as an outer side in the radial direction. A direction that rotates around the central axis O when viewed from the longitudinal direction Z is referred to as a circumferential direction.

### Optical Connector 1

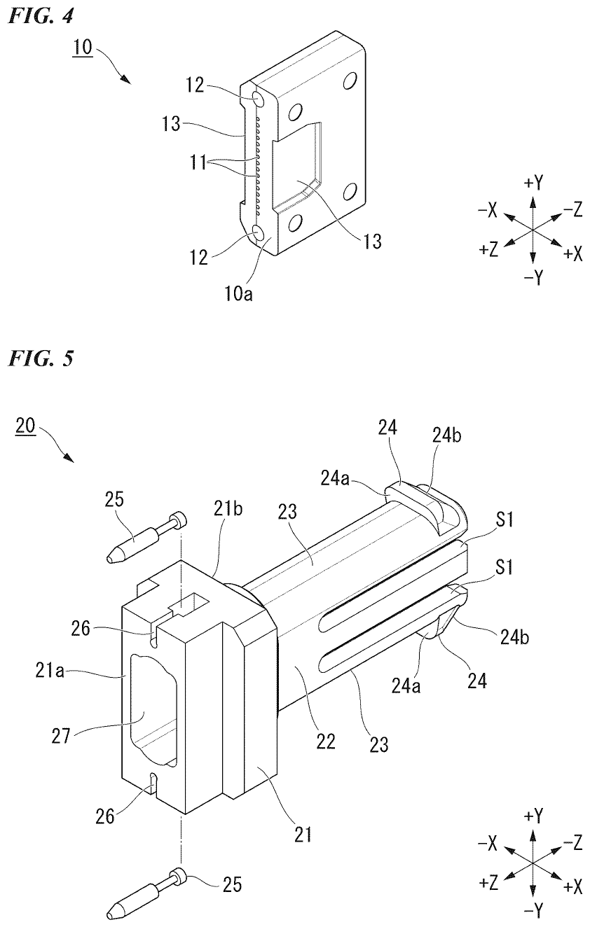

As shown in FIG. 4, the plurality of fiber holes 11 and a pair of guide holes 12 are formed in the ferrule 10 according to one or more embodiments. As shown in FIG. 3, the fiber holes 11 and the guide holes 12 are open to the connection end surface 10a and extend in a predetermined direction (rearward or −Z direction) to penetrate the ferrule 10 in the longitudinal direction Z. The pair of guide holes 12 are disposed at intervals in the second direction Y. The plurality of fiber holes 11 are located between the pair of guide holes 12 in the second direction Y and are aligned in the second direction Y (see also FIG. 4).

As shown in FIG. 3, the optical fiber F is inserted one by one into each of the plurality of fiber holes 11. In the shown example, a plurality of the optical fibers F are collectively coated with a coating material such as resin to form a single cable C. The coating is removed from the distal end portion of the cable C, exposing the optical fiber F. The exposed optical fiber F is inserted into the fiber hole 11. The distal end of each optical fiber F is located at the connection end surface 10a. The optical fiber F may be fixed to the fiber hole 11 using an adhesive or the like. The optical fiber F (cable C) that extends rearward from a rear end of the fiber hole 11 penetrates the holding member 20, the spring push 30, the biasing member 40, the release member 50, and the restricting portion 60 in the longitudinal direction Z. The number of fiber holes 11 and the number of optical fibers F can be appropriately changed as long as each is 1 or more.

As shown in FIG. 3, the guide pin 25 is inserted one by one into each of the pair of guide boles 12. In the female connector 1F according to one or more embodiments, the distal end of the guide pin 25 is located rearward from the connection end surface 10a. Although not shown, in the male connector 1M, the distal end of the guide pin 25 is located forward from the connection end surface 10a. With this configuration, when the male connector 1M and the female connector 1F are connected, the guide pin 25 provided in the male connector 1M is inserted into the guide hole 12 formed in the female connector 1F.

As shown in FIG. 4, a pair of fitting grooves 13 formed in the ferrule 10 according to one or more embodiments. Each fitting groove 13 is recessed inward in the first direction X from the side surface of the ferrule 10. Each fitting groove 13 is open to the connection end surface 10a.

As shown in FIG. 3, the holding member 20 according to one or more embodiments is attached to the rear end of the ferrule 10. As shown in FIG. 5, the holding member 20 according to one or more embodiments includes a holding base portion 21 and an extending portion 22 extending rearward from the holding base portion 21. A shape of the holding base portion 21 and a shape of the extending portion 22 in one or more embodiments are substantially rectangular in a cross-sectional view perpendicular to the longitudinal direction Z. In the present specification, the expression “substantially rectangular” also includes cases where the shape can be regarded as rectangular excluding chamfering or manufacturing errors.

Each of the dimensions of the extending portion 22 in the first direction X and the second direction Y are smaller than each of the dimensions of the holding base portion 21 in the first direction X and the second direction Y. In addition, a through-hole 27 that penetrates the holding base portion 21 and the extending portion 22 in the longitudinal direction Z is formed in the holding member 20. In other words, the holding member 20 has a tubular shape. The optical fiber F (cable C) is inserted into the through-hole 27 (see also FIG. 3).

As shown in FIG. 5, the holding base portion 21 includes a pressing surface 21a facing forward and a biased surface 21b located on the side opposite to the pressing surface 21a in the longitudinal direction Z. The biased surface 21b faces rearward. As shown in FIG. 3, the pressing surface 21a abuts the rear end of the ferrule 10. In addition, the biased surface 21b is located outside the extending portion 22 in the first direction X and the second direction Y when viewed from the longitudinal direction Z (see also FIG. 5).

As shown in FIG. 5, a pair of guide pin holding holes 26 are open to the pressing surface 21a. The through-hole 27 is located between the pair of guide pin holding holes 26 in the second direction Y. A rear end portion of the guide pin 25 is inserted into the guide pin holding hole 26. As a result, the guide pin 25 is held by the holding member 20. As shown in FIG. 3, by the guide pin 25 being inserted into the guide hole 12 of the ferrule 10 from rearward, the holding member 20 (holding base portion 21) holds the ferrule 10. That is, the holding member 20 according to one or more embodiments functions as a pin clamp.

As shown in FIG. 5, two slits S1 disposed at intervals in the second direction Y are formed on each side wall, which faces the first direction X, of the extending portion 22 according to one or more embodiments. That is, a total of four slits S1 are formed in the extending portion 22 according to one or more embodiments. The slit S1 is open at the rear end of the extending portion 22 and extends forward. By forming the four slits S1 as described above, part of the upper wall and part of the lower wall of the extending portion 22 can be elastically bent in the second direction Y. In one or more embodiments, each of the bendable parts is referred to as an engaging portion 23. More specifically, the two engaging portions 23 can be elastically bent in the second direction Y with the front end of each engaging portion 23 as the base end.

A first engaging protrusion 24 that protrudes outward in the second direction Y from the engaging portion 23 is provided at the rear end portion of the engaging portion 23. The first engaging protrusion 24 includes a first engaging surface 24a facing forward and an inclined surface 24b located on the side opposite to the first engaging surface 24a in the longitudinal direction Z. The inclined surface 24b is inclined gradually inward in the second direction Y as extending rearward.

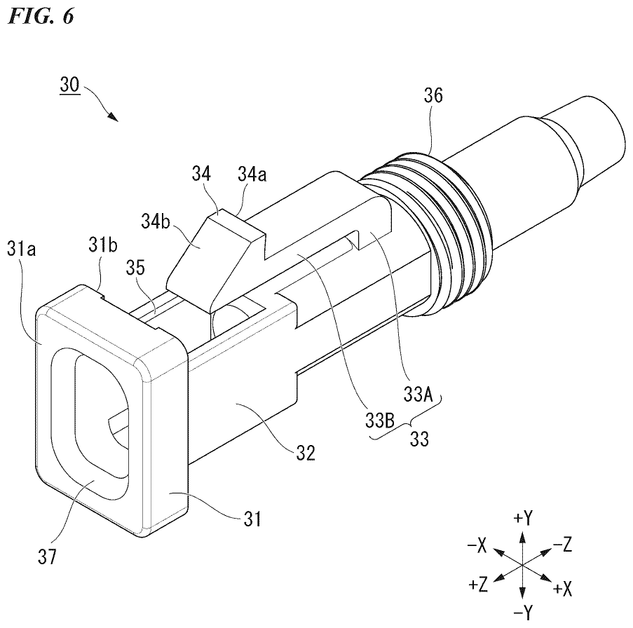

As shown in FIG. 3, the spring push 30 according to one or more embodiments is disposed to face the rear end of the ferrule 10 in the longitudinal direction Z. As shown in FIG. 6, the spring push 30 according to one or more embodiments includes a large-diameter portion 31 and a small-diameter portion 32 that extends rearward from the large-diameter portion 31. In one or more embodiments, the shape of the large-diameter portion 31 and the shape of the front end portion of the small-diameter portion 32 are substantially rectangular in a cross-sectional view perpendicular to the longitudinal direction Z. Each of the dimensions of the small-diameter portion 32 in the first direction X and the second direction Y is smaller than each of the dimensions of the large-diameter portion 31 in the first direction X and the second direction Y. In addition, a through-hole 37 that penetrates the large-diameter portion 31 and the small-diameter portion 32 in the longitudinal direction Z is formed in the spring push 30. In other words, the spring push 30 has a tubular shape. The optical fiber F (cable C) is inserted into the through-hole 37 (see also FIG. 3). In addition, as shown in FIG. 3, the rear end portion of the extending portion 22 is inserted into the through-hole 37.

As shown in FIG. 6, the large-diameter portion 31 includes a biasing surface 31a that faces forward and a first engaged surface 31b that is located on the side opposite to the biasing surface 31a and faces rearward.

As shown in FIG. 3, the biasing member 40 is disposed between the holding member 20 and the spring push 30 in the longitudinal direction Z. More specifically, the biasing member 40 according to one or more embodiments is interposed between the biased surface 21b of the holding member 20 and the biasing surface 31a of the spring push 30 in the longitudinal direction Z. In addition, the extending portion 22 of the holding member 20 penetrates the biasing member 40 in the longitudinal direction Z. The biasing member 40 is compressed between the biased surface 21b and the first engaged surface 31b, and biases the ferrule 10 forward through the pressing surface 21a of the holding member 20. That is, by abutting one end side of the biasing member 40 to part of the holding member 20 and abutting the other end side of the biasing member 40 to part of the spring push 30, the biasing member 40 biases the ferrule 10 held by the holding member 20 forward. For example, a coil spring can be used as the biasing member 40.

As shown in FIG. 6, a pair of engaged portions 35 are formed at the front end of the small-diameter portion 32 according to one or more embodiments (see also FIG. 3). The engaged portion 35 according to one or more embodiments is a hole that is open to the upper surface or the lower surface of the small-diameter portion 32 and communicates with the through-hole 37. Hereinafter, the engaged portion 35 may be referred to as an engaged hole 35. A shape of the engaged hole 35 according to one or more embodiments is substantially rectangular when viewed from the second direction Y.

In one or more embodiments, the engaging portion 23 and the engaged hole 35 are engaged with each other to restrict the holding member 20 from falling off from the spring push 30 due to the biasing force of the biasing member 40 and to allow the spring push 30 and the holding member 20 to approach each other. Hereinafter, the engagement between the engaging portion 23 and the engaged portion 35 in the example of one or more embodiments will be specifically described.

As shown in FIG. 3, in one or more embodiments, the first engaging protrusion 24 provided on the engaging portion 23 is inserted into the engaged hole 35. In addition, the first engaging surface 24a provided on the first engaging protrusion 24 is locked onto the first engaged surface 31b located at the front end of the engaged hole 35. As a result, even when the holding member 20 is biased forward by the biasing member 40, the holding member 20 is restricted from falling off forward from the spring push 30. In a state where the first engaging protrusion 24 is inserted into the engaged hole 35, the distance between the biasing surface 31a and the biased surface 21b in the longitudinal direction Z is shorter than the natural length of the biasing member 40.

In addition, in one or more embodiments, the dimension of the engaged hole 35 in the longitudinal direction Z is set to be larger than the dimension of the first engaging protrusion 24 in the longitudinal direction Z. Therefore, the first engaging protrusion 24 can move inside the engaged hole 35 in the longitudinal direction Z. Therefore, for example, when the ferrule 10 is pushed rearward, the holding member 20 can move rearward relative to the spring push 30 within the range where the first engaging protrusion 24 can move inside the engaged hole 35. That is, the holding member 20 and the spring push 30 are configured to approach each other in the longitudinal direction Z and to compress the biasing member 40.

In a case where the holding member 20 according to one or more embodiments is attached to the spring push 30 (that is, the engaging portion 23 and the engaged hole 35 are engaged with each other), the extending portion 22 may be inserted into the through-hole 37 from forward. When the extending portion 22 is inserted into the through-hole 37, the inclined surface 24b abuts the inner peripheral surface of the through-hole 37 and the engaging portion 23 is elastically deformed to bend inward in the second direction Y. Further, when the extending portion 22 is pushed into the through-hole 37, the first engaging protrusion 24 reaches the engaged hole 35, releasing the bending of the engaging portion 23, and the first engaging surface 24a is locked onto the first engaged surface 31b. In this way, since the engaging portion 23 can be elastically deformed and the first engaging protrusion 24 with the inclined surface 24b is provided on the engaging portion 23, the holding member 20 can be easily attached to the spring push 30. In a case where the holding member 20 is attached to the spring push 30, the biasing member 40 may be provided between the holding member 20 and the spring push 30.

As shown in FIG. 6, the spring push 30 according to one or more embodiments includes an engaging claw 33 that protrudes from the outer peripheral surface of the small-diameter portion 32. The engaging claw 33 according to one or more embodiments includes a first portion 33A that extends upward from a central portion of the small-diameter portion 32 in the longitudinal direction Z, and a second portion 33B that extends forward from the upper end of the first portion 33A. The shape of the engaging claw 33 according to one or more embodiments is substantially L-shaped when viewed from the first direction X. The expression “substantially L-shaped” also includes cases where the shape can be regarded as L-shaped excluding chamfering or manufacturing errors. The engaging claw 33 according to one or more embodiments can be elastically bent in the second direction Y with the lower end of the first portion 33A as the base end.

A second engaging protrusion 34 that protrudes upward from the engaging claw 33 is provided at the front end of the engaging claw 33 (second portion 33B). The second engaging protrusion 34 includes a second engaging surface 34a facing rearward and an inclined surface 34b located on the side opposite to the second engaging surface 34a in the longitudinal direction Z. The inclined surface 34b is inclined gradually downward as extending forward.

As shown in FIG. 6, a screwed portion 36, which is formed with a spiral protrusion, is provided on part of the outer peripheral surface of the small-diameter portion 32 according to one or more embodiments. The screwed portion 36 is located rearward from the engaging claw 33. In addition, as shown in FIG. 3, a tube T that protects the optical fiber F (cable C) is fixed to the rear end portion of the small-diameter portion 32.

As shown in FIG. 3, the restricting portion 60 according to one or more embodiments is a cylindrical member extending in the longitudinal direction Z (see also FIG. 2). As shown in FIG. 3, a screwing portion 61, which is formed with a spiral protrusion that is screwed with the screwed portion 36, is provided on part of the inner peripheral surface of the restricting portion 60. In one or more embodiments, the screwing portion 61 is located at the front end of the restricting portion 60. The restricting portion 60 is fixed to the spring push 30 by screwing the screwing portion 61 to the screwed portion 36. In addition, the restricting portion 60 has a restricting surface 60a facing forward.

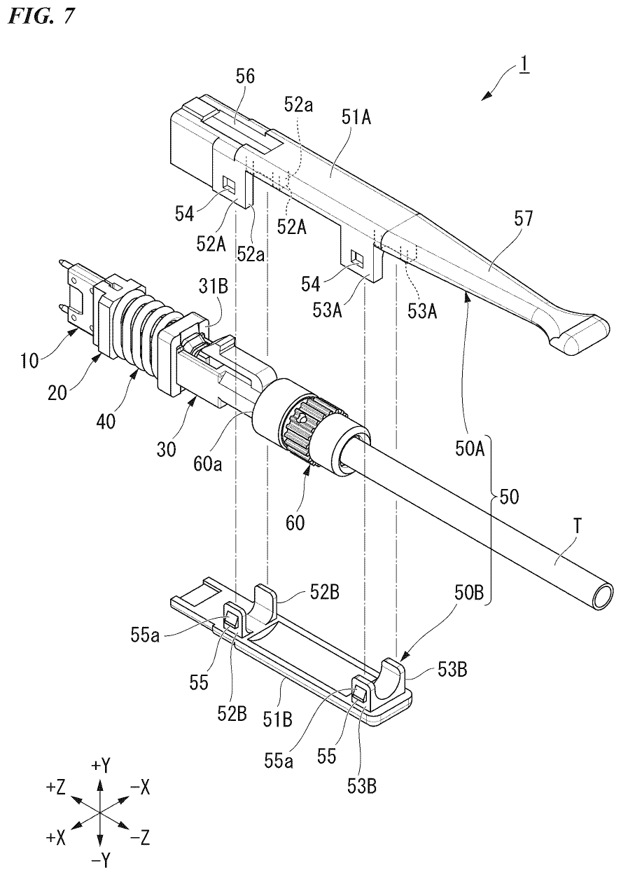

As shown in FIG. 7, the release member 50 according to one or more embodiments includes a first member 50A and a second member 50B. The first member 50A includes a first base portion 51A, a pair of first front side connecting portions 52A, a pair of first rear side connecting portions 53A, and a handle 57. The second member 50B includes a second base portion 51B, a pair of second front side connecting portions 52B, and a pair of second rear side connecting portions 53B.

The base portions 51A and 51B according to one or more embodiments have a flat plate shape extending in the first direction X and the second direction Y. The first base portion 51A and the second base portion 51B face each other in the second direction Y. A window 56 that penetrates the first base portion 51A in the second direction Y is formed in the first base portion 51A. A shape of the window 56 according to one or more embodiments is substantially rectangular when viewed from the second direction Y. In addition, as shown in FIG. 3, in the first base portion 51A according to one or more embodiments, a pressing surface 56a connecting the front end of the window 56 and the lower surface of the first base portion 51A is formed. The pressing surface 56a is inclined gradually downward as extending forward. The handle 57 extends rearward from the rear end of the first base portion 51A.

As shown in FIG. 7, the pair of first front side connecting portions 52A are located at the front end portion of the first base portion 51A and extend downward from both ends of the first base portion 51A in the first direction X. Each first front side connecting portion 52A bas a restricted surface 52a facing rearward. The pair of first rear side connecting portions 53A are located at the rear end portion of the first base portion 51A and extend downward from both ends of the first base portion 51A in the first direction X. A connecting hole 54 penetrating the first connecting portions 52A and 53A in the first direction X is formed in each of the first connecting portions 52A and 53A.

The pair of second front side connecting portions 52B extend upward from both end portions of the second base portion 51B in the first direction X. The pair of second rear side connecting portions 53B extend upward from both end portions of the second base portion 51B in the first direction X. The second connecting portions 52B and 53B are provided with connecting protrusions 55 that protrude outward in the first direction X from the second connecting portions 52B and 53B. In addition, the connecting protrusion 55 includes an inclined surface 55a that is inclined gradually outward in the first direction X as extending downward. Each of the positions of the second connecting portions 52B and 53B in the longitudinal direction Z corresponds to each of the positions of the first connecting portions 52A and 53A in the longitudinal direction Z. In addition, the pair of second front side connecting portions 52B are located on the inner side in the first direction X relative to the pair of first front side connecting portions 52A. Similarly, the pair of second rear side connecting portions 53B are located on the inner side in the first direction X relative to the pair of first rear side connecting portions 53A.

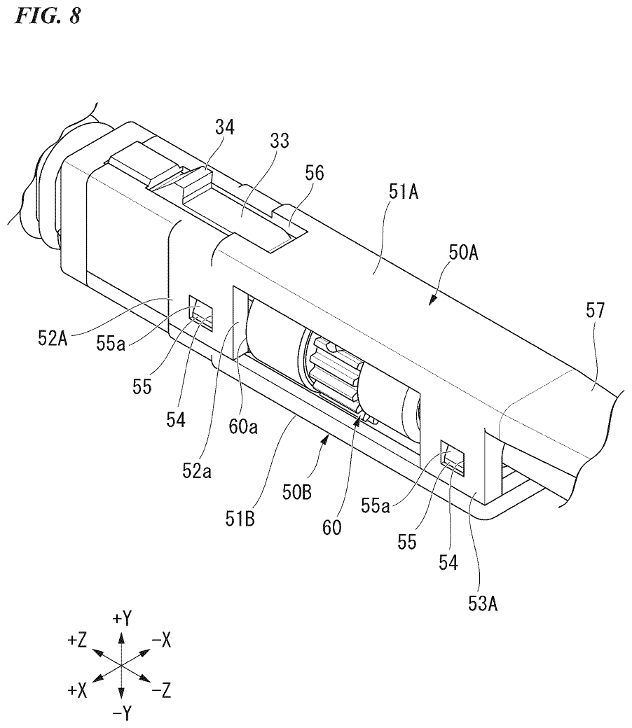

In one or more embodiments, the first member 50A and the second member 50B are connected to each other to interpose at least part of the spring push 30 in the second direction Y. More specifically, by inserting the connecting protrusion 55 of the second front side connecting portion 52B into the connecting hole 54 of the first front side connecting portion 52A and by inserting the connecting protrusion 55 of the second rear side connecting portion 53B into the connecting hole 54 of the first rear side connecting portion 53A, the first member 50A and the second member 50B are connected to each other. Since the connecting protrusion 55 has the inclined surface 55a, the first member 50A and the second member 50B can be easily connected. In addition, as shown in FIGS. 8 and 3, the members 50A and 50B are connected such that the engaging claw 33 of the spring push 30 is located inside the window 56.

As shown in FIG. 8, the restricting portion 60 according to one or more embodiments is located between the first front side connecting portion 52A and the first rear side connecting portion 53A in the longitudinal direction Z when the members 50A and 50B are connected to each other. In addition, the outer shape of the restricting portion 60 is designed to be larger than the interval between the pair of first front side connecting portions 52A in the first direction X. As a result, when the first member 50A and the second member 50B are connected to each other, the restricting surface 60a of the restricting portion 60 and the restricted surface 52a of the first front side connecting portion 52A face each other in the longitudinal direction Z.

### Optical Connector Assembly 2

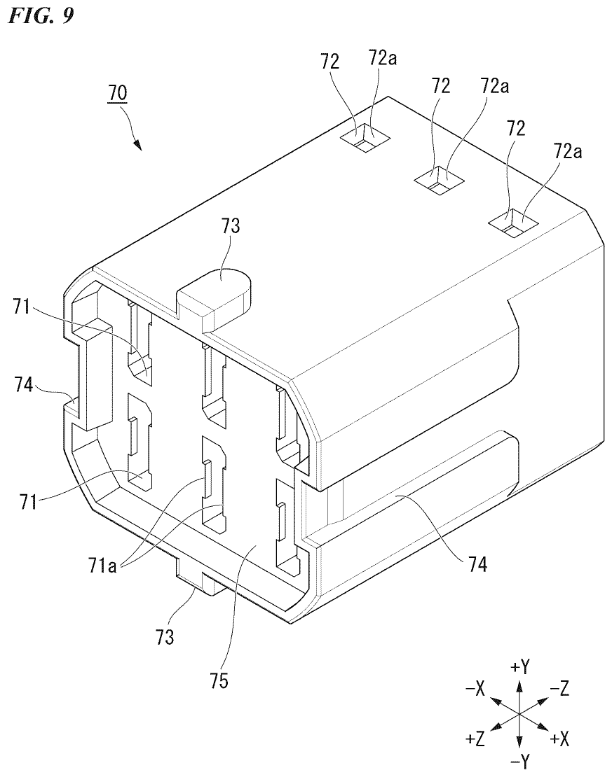

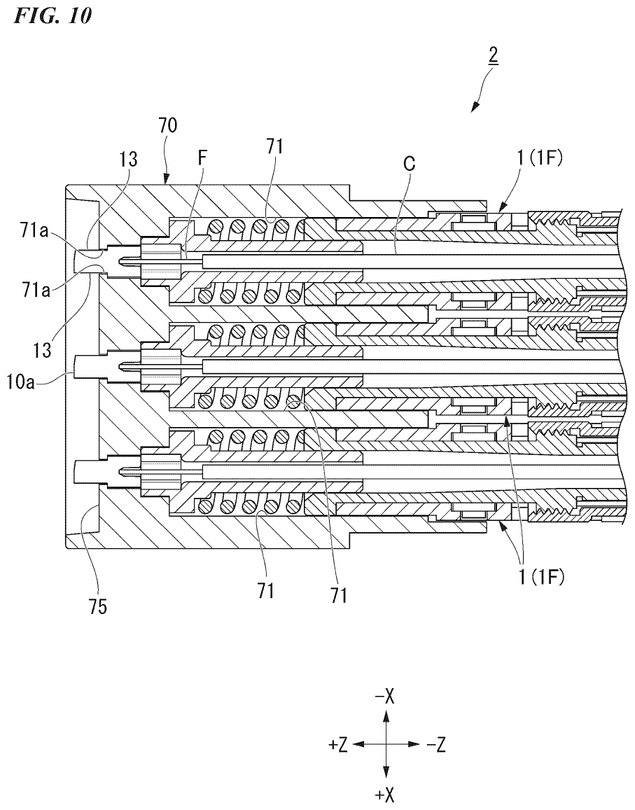

As shown in FIGS. 9 to 11, a plurality (six in the shown example) of connector insertion holes 71 that are open at the rear end of the adapter 70 are formed in the adapter 70 according to one or more embodiments. The optical connector 1 (female connector 1F) is inserted one by one into each of the plurality of connector insertion holes 71. In addition, a recessed portion 75 that is recessed rearward is formed on the front surface of the adapter 70 according to one or more embodiments. Each connector insertion hole 71 is open to the recessed portion 75. FIG. 10 is a cross-sectional view of the optical connector assembly 2 in a region including three optical connectors 1 arranged in the first direction X. As shown in FIG. 10, in the optical connector assembly 2 according to one or more embodiments, the connection end surface 10a of the optical connector 1 inserted into the connector insertion hole 71 is located inside the recessed portion 75.

As shown in FIG. 9, the adapter 70 according to one or more embodiments has a pair of protruding portions 73. Each protruding portion 73 protrudes outward from the upper surface or the lower surface of the adapter 70 in the second direction Y. Each protruding portion 73 is located at the distal end portion of the adapter 70 and at the central portion in the first direction X. In addition, in the adapter 70 according to one or more embodiments, a pair of guide grooves 74 recessed inward in the first direction X are formed on the side surface of the adapter 70. Each guide groove 74 extends in the longitudinal direction Z and is located at the central portion of the adapter 70 in the second direction Y.

As shown in FIG. 10, the shape of the connector insertion hole 71 corresponds to the outer shape of the optical connector 1. A fitting protrusion 71a that protrudes inward in the first direction X from the inner peripheral surface of the connector insertion hole 71 is provided at the front end of each connector insertion hole 71 (see also FIG. 9). In the examples of FIGS. 9 and 10, a pair of the fitting protrusions 71a are provided in one connector insertion hole 71. The fitting protrusion 71a fits into the fitting groove 13 formed in the ferrule 10. By fitting the fitting protrusion 71a into the fitting groove 13, the position of the ferrule 10 in the adapter 70 can be stabilized, and the connection between the optical connectors 1 (male connector 1M and female connector 1F) can be stabilized. The configuration using the fitting protrusion 71a and the fitting groove 13 achieves an effect of ensuring connection stability even for an extremely small ferrule 10, for example, a size of about several millimeters.

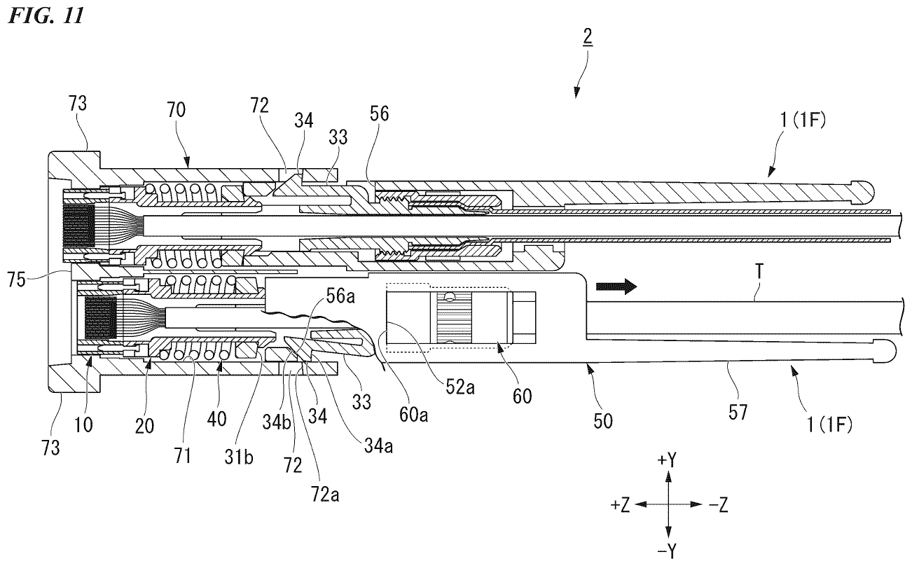

FIG. 11 is a cross-sectional view of the optical connector assembly 2 in a region including two optical connectors 1 arranged in the second direction Y. For the sake of explanation, of the two optical connectors 1 shown in FIG. 11, the optical connector 1 located on the upper part (+Y side) shows a state in which the optical connector 1 is engaged with the adapter 70 and the optical connector 1 located on the lower part (−Y side) shows a state immediately after the engagement with the adapter 70 is released. As shown in FIGS. 9 and 11, a plurality of engaging holes 72 are formed in the adapter 70 according to one or more embodiments. The plurality of connector insertion holes 71 and the plurality of engaging holes 72 correspond to each other one-to-one. Each engaging hole 72 is open to the upper surface or the lower surface of the adapter 70 and penetrates to the corresponding connector insertion hole 71. The connector insertion hole 71 located on the upper part (+Y side) of the adapter 70 communicates with the engaging hole 72 that is open to the upper surface of the adapter 70 and the connector insertion hole 71 located on the lower part (−Y side) of the adapter 70 communicates with the engaging hole 72 that is open to the lower surface of the adapter 70. Each engaging hole 72 has a second engaged surface 72a facing forward.

As shown in FIG. 11, in the optical connector assembly 2 according to one or more embodiments, the optical connector 1 is inserted into the connector insertion hole 71 such that the engaging claw 33 and the engaging hole 72 engage with each other. The user can insert the optical connector 1 into the connector insertion hole 71 by gripping the handle 57 and pushing the handle 57 forward. More specifically, when the handle 57 is pushed forward, the front end of the release member 50 presses the first engaged surface 31b of the spring push 30 forward. As a result, the pressing force applied by the user is transmitted to the spring push 30, and further, the transmitted force is transmitted to the holding member 20 and the ferrule 10 via the biasing member 40. Therefore, the entire optical connector 1 moves forward. In addition, when the optical connector 1 is brought close to the connector insertion hole 71 from rearward, the inclined surface 34b of the engaging claw 33 abuts the inner peripheral surface of the connector insertion hole 71 and the engaging claw 33 bends inward in the second direction Y. Further, when the optical connector 1 is pushed forward, the second engaging protrusion 34 reaches the engaging hole 72, releasing the bending of the engaging claw 33, and the second engaging surface 34a is locked onto the second engaged surface 72a. That is, the optical connector 1 is fixed inside the connector insertion hole 71. The above-described insertion method using the handle 57 is suitable in that the workability of the user is less likely to be impaired even when the optical connectors 1 are arranged at a high density.

In addition, the user can remove the optical connector 1 from the connector insertion hole 71 by gripping the handle 57 and pulling the handle 57 rearward (see the optical connector 1 located on the lower part (−Y side) in FIG. 11). More specifically, when the handle 57 is pulled rearward, the pressing surface 56a of the release member 50 abuts the inclined surface 34b of the engaging claw 33 and the engaging claw 33 bends inward in the second direction Y. As a result, the second engaging surface 34a and the second engaged surface 72a are separated, and the engagement between the engaging claw 33 and the engaging hole 72 is released. Further, when the handle 57 is pulled rearward, the restricted surface 52a of the release member 50 abuts the restricting surface 60a of the restricting portion 60 and the restricting surface 60a is pressed rearward. That is, the restricting portion 60 serves to restrict the release member 50 from falling off rearward from the optical connector 1 (spring push 30) and to reliably transmit the force of pulling the handle 57 by the user to the optical connector 1. The distance between the restricted surface 52a and the restricting surface 60a may be appropriately adjusted such that the front end of the release member 50 does not move rearward from the second engaging protrusion 34 even when the user pulls the release member 50. In this case, the optical connector 1 can be inserted again into the connector insertion bole 71 using the release member 50 after the optical connector 1 is removed from the connector insertion hole 71. For example, the distance between the restricted surface 52a and the restricting surface 60a may be appropriately adjusted such that the contact between the pressing surface 56a and the inclined surface 34b is maintained when the user pulls the release member 50.

### Optical Connecting Structure 100

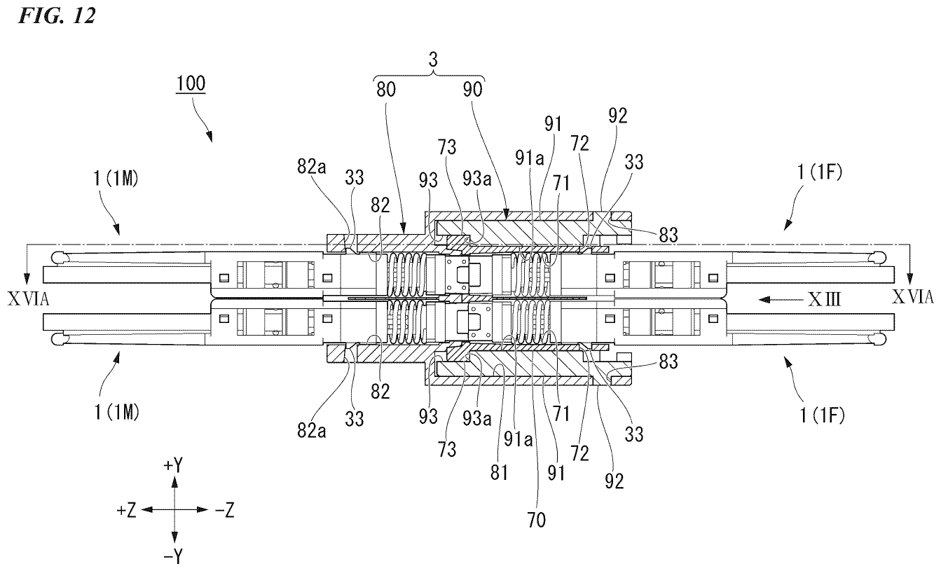

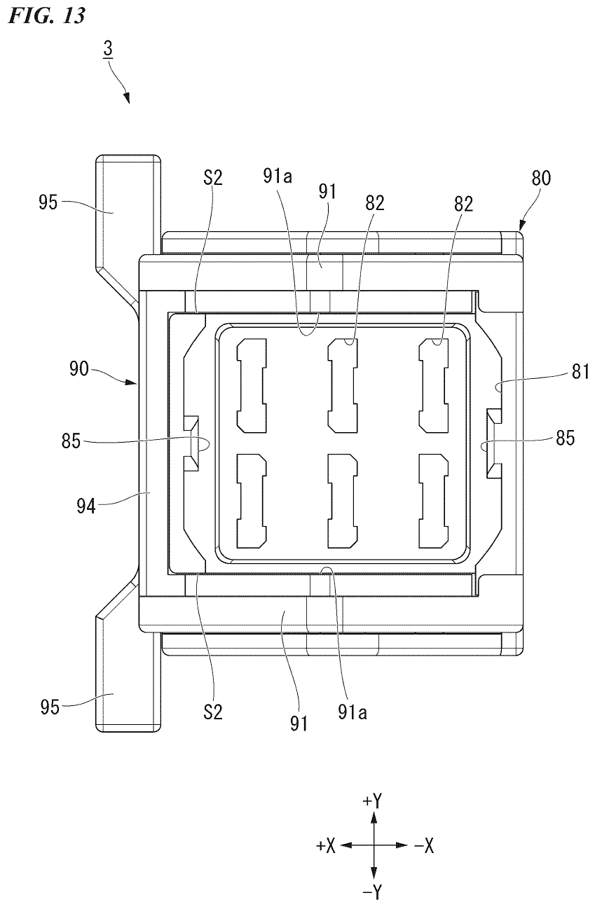

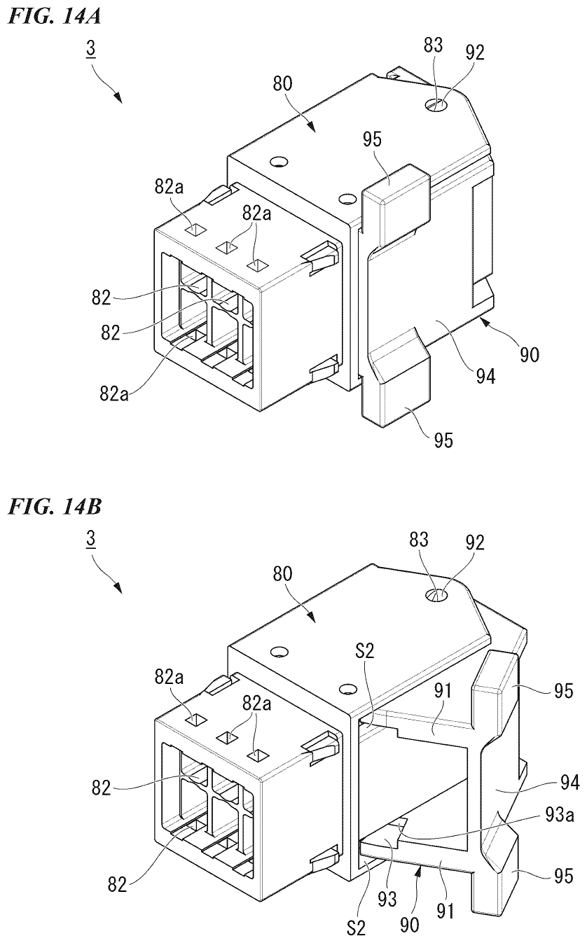

FIG. 12 is a cross-sectional view of the optical connecting structure 100, showing a state in which two male connectors 1M arranged in the second direction Y and two female connectors 1F arranged in the second direction Y are connected to each other. As shown in FIGS. 12 and 13, the receptacle 3 according to one or more embodiments includes a main body portion 80 and a rotating portion 90 attached to the main body portion 80. The rotating portion 90 according to one or more embodiments is attached to the main body portion 80 such that the rotating portion 90 is switchable between the state shown in FIG. 14A and the state shown in FIG. 14B by a rotational movement. Hereinafter, the state shown in FIG. 14A may be referred to as the “fixed state”, and the state shown in FIG. 14B may be referred to as the “non-fixed state”. In addition, hereinafter, unless otherwise specified, the positional relationship among the members is described assuming that the rotating portion 90 is in the fixed state.

As shown in FIGS. 12 and 13, one adapter insertion hole 81 that is open to the rear surface of the main body portion 80 and a plurality (six in the shown example) of connector insertion boles 82 that are open to the front surface of the main body portion 80 are formed in the main body portion 80 according to one or more embodiments. The optical connector assembly 2 is inserted into the adapter insertion hole 81. Each connector insertion hole 82 communicates with the adapter insertion hole 81.

The male connector 1M is inserted one by one into each of the plurality of connector insertion holes 82. As shown in FIG. 12, an engaging hole 82a that penetrates to the upper surface or the lower surface of the main body portion 80 is open to the inner peripheral surface of each connector insertion hole 82. In the optical connecting structure 100 according to one or more embodiments, the male connector 1M is inserted into the connector insertion hole 82 such that the engaging claw 33 and the engaging hole 82a engage with each other. The user can insert and remove the male connector 1M into and from the connector insertion hole 82 by gripping the handle 57 and pushing and pulling the male connector 1M with respect to the connector insertion hole 82. The principle that allows the male connector 1M to be inserted into and removed from the connector insertion hole 82 is the same as the principle described above that allows the optical connector 1 (female connector 1F) to be inserted into and removed from the connector insertion hole 71. Therefore, a detailed description will be omitted.

As shown in FIG. 13, a guide protrusion 85 that protrudes inward in the first direction X is provided on the inner peripheral surface of the adapter insertion hole 81 according to one or more embodiments. The shape of the guide protrusion 85 corresponds to the shape of the guide groove 74 formed in the adapter 70 (see also FIG. 9). The adapter 70 according to one or more embodiments is inserted into the adapter insertion hole 81 such that the guide protrusion 85 is fitted into the guide groove 74.

As shown in FIG. 13, a pair of slits S2 that penetrate the outer peripheral surface of the main body portion 80 are formed on the side surface of the adapter insertion hole 81 on the front side (+X side). The pair of slits S2 are disposed at intervals in the second direction Y and are located at both end portions of the main body portion 80 in the second direction Y. Each slit S2 is open at the rear end of the main body portion 80 and extends in the longitudinal direction Z (see also FIG. 14B). As shown in FIG. 12, a pair of support shaft holes 83, which open to the upper surface and the lower surface of the adapter insertion hole 81 and penetrate the outer peripheral surface of the main body portion 80, are open to the rear end portion of the main body portion 80.

As shown in FIG. 13, the rotating portion 90 according to one or more embodiments includes a pair of rotation base portions 91, a connecting portion 94, and a pair of handles 95. Each rotation base portion 91 is a plate-shaped member extending in the first direction X and the longitudinal direction Z (see also FIGS. 14A and 14B). Each rotation base portion 91 has a facing surface 91a that faces inward in the second direction Y. In the fixed state, the rotation base portion 91 penetrates the slit S2 and extends along the upper surface or the lower surface of the connector insertion hole 82. The connecting portion 94 is a plate-shaped member that connects the end portions of the rotation base portions 91 on the front side (+X side) to each other (see also FIGS. 14A and 14B). The connecting portion 94 is located outside the main body portion 80. The pair of handles 95 are provided at both end portions of the connecting portion 94 in the second direction Y.

As shown in FIG. 12, the rotating portion 90 according to one or more embodiments includes a pair of support shaft protrusions 92 that protrude outward in the second direction Y from the outer peripheral surface of the rotating portion 90 (rotation base portion 91). The support shaft protrusion 92 is inserted into the support shaft hole 83 of the main body portion 80. As shown in FIGS. 14A and 14B, the rotating portion 90 is configured to be rotationally moved with the support shaft protrusion 92 as the support shaft by inserting the support shaft protrusion 92 into the support shaft hole 83. The user can grip the handle 95 to rotationally move the rotating portion 90. As a result, the user can move the rotation base portion 91 in and out of the adapter insertion bole 81 through the slit S2. In other words, the rotating portion 90 can be switched between a fixed state and a non-fixed state.

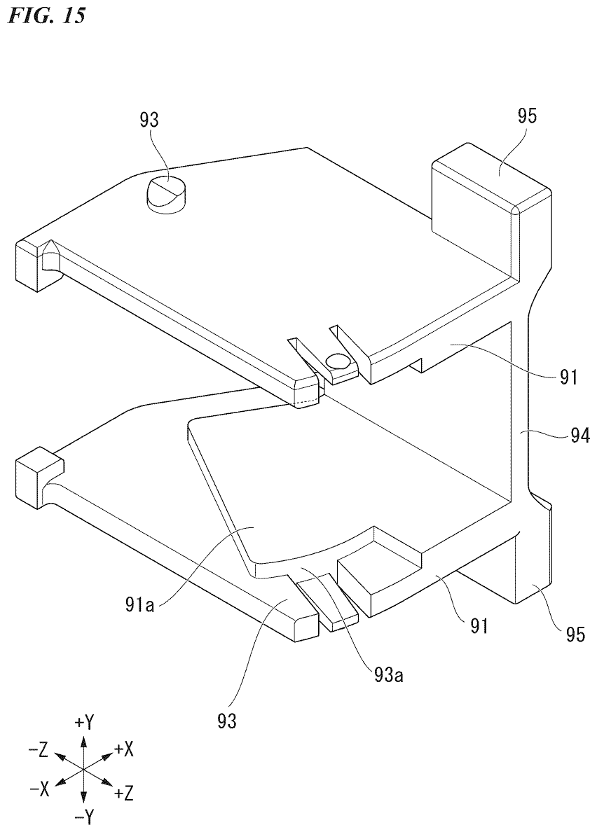

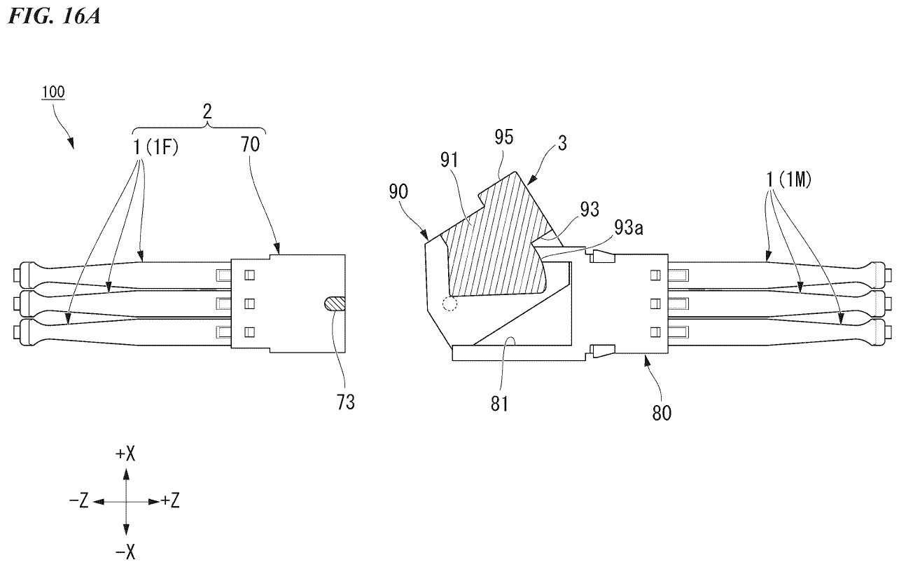

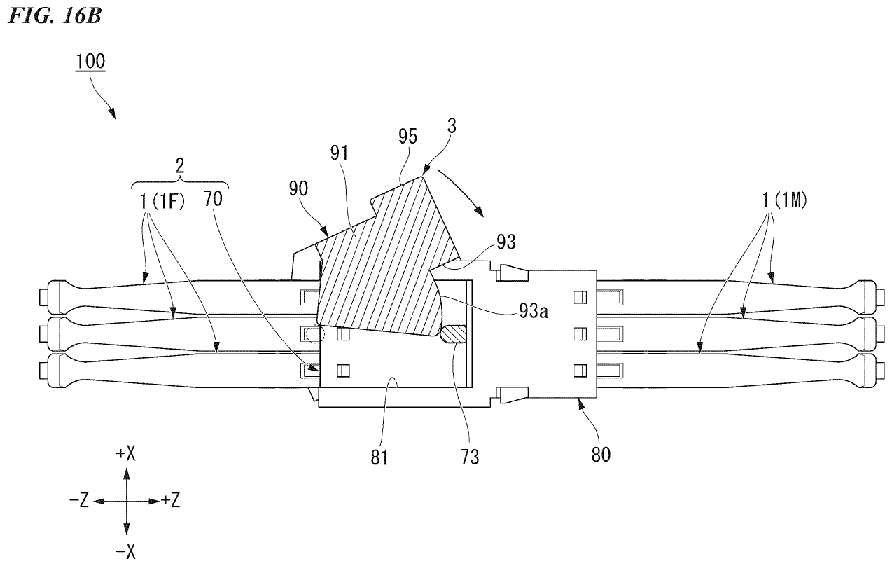

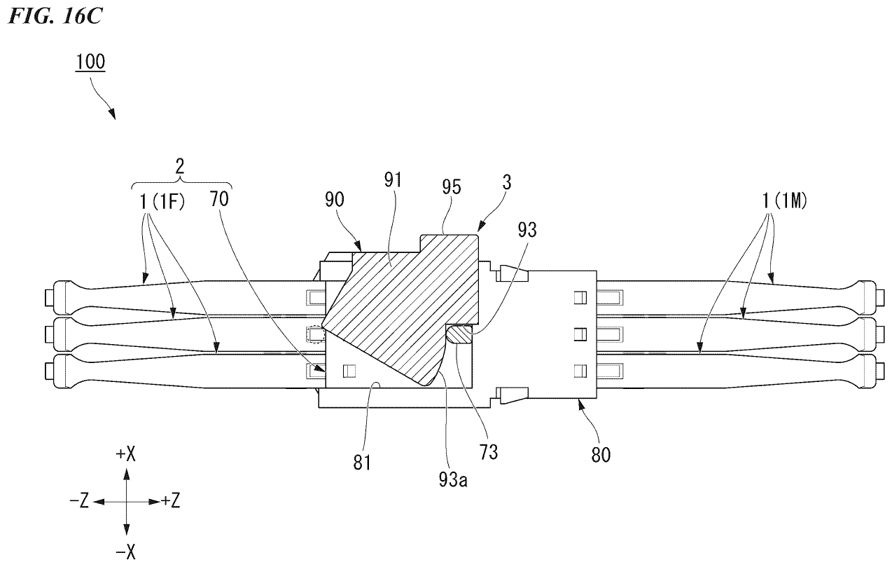

As shown in FIG. 15, a recessed portion 93 that is recessed outward from each facing surface 91a in the second direction Y is formed in the rotation base portion 91 according to one or more embodiments. The protruding portion 73 of the adapter 70 is fitted into the recessed portion 93 in the fixed state (see also FIGS. 12 and 16C). In one or more embodiments, at least part of the inner surface of the recessed portion 93 is a convex curved surface 93a as shown in FIG. 15. The shape of the curved surface 93a may be, for example, an arc shape when viewed from the second direction Y or an elliptical arc shape. The curved surface 93a is located at the front end portion of the rotation base portion 91. As shown in FIGS. 12 and 16C, in the fixed state, the curved surface 93a abuts the protruding portion 73 from rearward. As a result, the adapter 70 (optical connector assembly 2) is fixed to the adapter insertion hole 81 (main body portion 80).

Next, a method of connecting the female connector 1F and the male connector 1M using the receptacle 3 according to one or more embodiments will be described.

First, the male connector 1M is inserted one by one into each of the plurality of connector insertion holes 82 formed in the receptacle 3, and the engaging claw 33 and the engaging hole 82a are engaged with each other (see FIG. 12). The receptacle 3 may be fixed to a panel or the like provided in the data center.

Next, the female connector 1F (optical connector 1) is inserted one by one into each of the plurality of connector insertion holes 71 formed in the adapter 70, and the engaging claw 33 and the engaging hole 72 are engaged with each other (see FIG. 11). That is, the optical connector assembly 2 is assembled using the adapter 70 and the plurality of female connectors 1F.

Next, the optical connector assembly 2 is inserted into the adapter insertion hole 81 of the receptacle 3. As shown in FIG. 16A, when the optical connector assembly 2 is inserted, the rotating portion 90 is set to a non-fixed state.

Next, as shown in FIG. 16B, the rotating portion 90 is rotated from the non-fixed state to the fixed state. As a result, the curved surface 93a of the rotating portion 90 abuts the protruding portion 73 of the adapter 70.

Here, the curved surface 93a according to one or more embodiments is configured to gradually press the protruding portion 73 forward as the rotating portion 90 is switched from the non-fixed state to the fixed state by the rotational movement. In other words, by engaging the curved surface 93a and the protruding portion 73 with each other, the rotational movement of the rotating portion 90 is converted into the linear movement of the adapter 70 (optical connector assembly 2) in the longitudinal direction Z. The convex shape of the curved surface 93a may be appropriately adjusted such that the conversion of the movement direction by the curved surface 93a and the protruding portion 73 is performed smoothly.

With this configuration, as shown in FIG. 16C, when the rotating portion 90 is rotated from the non-fixed state to the fixed state, the adapter 70 moves forward. Accordingly, each female connector 1F can be pressed toward the male connector 1M against the biasing force of the biasing member 40. That is, the biasing member 40 of the connectors 1F and 1M can be compressed in the longitudinal direction Z, and the ferrules 10 can be connected to each other by the biasing force of the biasing member 40.

As described above, by using the rotational movement of the rotating portion 90 in the connection of the connectors 1F and 1M, the principle can be used for the connection of the connectors 1F and 1M. Therefore, for example, compared to a configuration in which the user directly presses the female connector 1F against the male connector 1M to connect the connectors 1F and 1M, the force that the user needs to apply when connecting the connectors 1F and 1M with each other can be reduced.

As described above, when the rotating portion 90 is rotated to the fixed state, the curved surface 93a and the protruding portion 73 engage with each other, and the adapter 70 (optical connector assembly 2) is fixed to the adapter insertion hole 81 (main body portion 80). In a case where the optical connector assembly 2 is pulled out from the receptacle 3, the user rotates the rotating portion 90 from the fixed state to the non-fixed state. In the non-fixed state, the curved surface 93a and the protruding portion 73 are separated, allowing the optical connector assembly 2 to be removed from the adapter insertion hole 81 (main body portion 80). The user can remove the optical connector assembly 2 from the receptacle 3 by pulling the optical connector assembly 2 while setting the rotating portion 90 to the non-fixed state.

With the optical connecting structure 100 according to one or more embodiments, it is also possible to remove female connector 1F one by one from the receptacle 3 after the optical connector assembly 2 is inserted into the adapter insertion hole 81. That is, the user can individually remove each female connector 1F from the adapter 70 by pulling the handle 57 of the female connector 1F to be removed.

Next, the operation of the optical connector 1, the optical connector assembly 2, and the optical connecting structure 100 configured as described above will be described.

In the related art, an optical connector having a floating structure is known. The optical connector having a floating structure includes, for example, a ferrule, a biasing member, a spring push, and a housing that accommodates these three components. In order to mechanically connect the ferrule of the optical connector to the ferrule of another optical connector, a floating mechanism is required for the ferrule. In order to apply the floating mechanism while maintaining the positional relationship among these three components, a slightly larger housing is used to accommodate these three components. However, when the optical connector includes a housing, of course, it is difficult to arrange a plurality of optical connectors at intervals shorter than the dimension of the housing. That is, the presence of the housing has created an upper limit on the arrangement density of the optical fibers. Therefore, in order to further improve the arrangement density of the optical fibers, an optical connector without a housing has been desired.

The optical connector 1 according to one or more embodiments includes the holding member 20, which holds the ferrule 10, including the engaging portion 23, and the spring push 30 including the engaged portion 35 that engages with the engaging portion 23. With this configuration, by engaging the engaging portion 23 and the engaged portion 35 with each other, the positional relationship among the ferrule 10 held by the holding member 20, the spring push 30, and the biasing member 40 that biases the ferrule 10 forward by abutting one end side to the holding member 20 and abutting the other end side to the spring push 30, can be maintained. That is, the floating mechanism can be maintained without the housing. Therefore, the biasing member 40 is maintained in a state of exerting a biasing force on the ferrule 10, and the ferrule 10 is maintained in a floating state, allowing the ferrule 10 to move forward and rearward in the longitudinal direction Z. In addition, the optical connector 1 according to one or more embodiments does not have a housing that individually accommodates the optical connector 1. Therefore, the arrangement density of the optical connector 1 and the optical fiber F accommodated in the optical connector 1 can be increased. In addition, by using the optical connector 1 according to one or more embodiments, it is possible to realize the optical connector assembly 2 and the optical connecting structure 100 with an increased arrangement density of the optical fibers F.

As described above, the optical connector 1 according to one or more embodiments includes the ferrule 10 including the connection end surface 10a where the fiber bole 11 through which the optical fiber F is inserted is open, the holding member 20 that holds the ferrule 10, a spring push 30, the biasing member 40 that biases the ferrule 10 by abutting one end to the holding member 20 and abutting the other end to the spring push 30, in which the holding member 20 includes the engaging portion 23, and the spring push 30 includes the engaged portion 35 that engages with the engaging portion 23.

With this configuration, even without a housing, the positional relationship among the ferrule 10, the biasing member 40, and the spring push 30 can be maintained. In addition, since the optical connector 1 does not have a housing, the arrangement density of the optical connector 1 and the optical fiber F accommodated in the optical connector 1 can be increased.

In addition, the holding member 20 includes the extending portion 22 that extends toward the spring push 30 and penetrates the biasing member 40, and the engaging portion 23 is provided on the extending portion 22. With this configuration, it is possible to easily realize the extending portion 22 that engages with the engaged portion 35.

In addition, the engaged portion 35 is a hole (engaged hole 35) into which at least part of the engaging portion 23 (first engaging protrusion 24) is inserted, and the engaging portion 23 and the engaged hole 35 are engaged with each other to restrict the holding member 20 from falling off from the spring push 30 due to a biasing force of the biasing member 40 and to allow the holding member 20 and the spring push 30 to approach each other. With this configuration, it is possible to easily realize the engaged portion 35 that engages with the engaging portion 23 such that the ferrule 10 is maintained in a floating state.

In addition, the optical connector 1 according to one or more embodiments further includes the release member 50 configured to cover at least part of the spring push 30 from an outer side in a radial direction (second direction Y), in which the spring push 30 includes the engaging claw 33 that engages with the adapter 70, and when the release member 50 is pulled rearward, the release member 50 bends the engaging claw 33 toward the radial direction (second direction Y) to release the engagement between the engaging claw 33 and the adapter 70. With this configuration, the optical connector 1 can be easily removed from the adapter 70 by using the release member 50.

In addition, the release member 50 includes the first member 50A and the second member 50B that are connected to each other to interpose at least part of the spring push 30 in the radial direction (second direction Y). With this configuration, the workability of attaching the release member 50 to the spring push 30 can be improved. More specifically, the release member 50 can be easily attached to the spring push 30 even after the optical fiber F has been inserted into the spring push 30.

In addition, the optical connector 1 according to one or more embodiments further includes the restricting portion 60 configured to restrict the release member 50 from falling off rearward from the spring push 30. With this configuration, the workability of inserting and removing the optical connector 1 into and from the adapter 70 using the release member 50 can be improved.

In addition, the optical connector assembly 2 according to one or more embodiments includes a plurality of the optical connectors 1 described above and the adapter 70 into which the plurality of optical connectors 1 are inserted, in which the adapter 70 includes a plurality of engaging holes 72 with which a plurality of the engaging claws 33 is engaged. With this configuration, it is possible to realize the optical connector assembly 2 with an increased arrangement density of the optical fiber F. In addition, since the optical connector 1 does not have a housing, the optical connector assembly 2 can be reduced in size compared to a configuration in which an optical connector having a housing is inserted into the adapter.

In addition, the optical connecting structure 100 according to one or more embodiments includes the optical connector assembly 2 described above and the receptacle 3 including the main body portion 80 and the rotating portion 90 attached to the main body portion 80, in which the rotating portion 90 is attached to the main body portion 80 such that the rotating portion 90 is switchable between a fixed state in which the optical connector assembly 2 is fixed to the main body portion 80 and a non-fixed state in which the optical connector assembly 2 is allowed to be removed from the main body portion 80 by a rotational movement, the adapter 70 includes the protruding portion 73 that protrudes from the outer peripheral surface of the adapter 70, and the rotating portion 90 is provided with a convex curved surface 93a that gradually presses the protruding portion 73 forward as the rotating portion 90 is switched from the non-fixed state to the fixed state by the rotational movement. With this configuration, it is possible to realize the optical connecting structure 100 with an increased arrangement density of the optical fiber F. In addition, the force that the user needs to apply when connecting the optical connectors 1 (female connector 1F and male connector 1M) with each other can be reduced by the lever principle.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

For example, in one or more embodiments, the holding member 20 is described as functioning as the pin clamp, but the configuration of the holding member 20 is not limited to this. That is, the holding member 20 does not have to have the guide pin 25 and the guide pin holding bole 26. In this case, the guide hole 12 does not have to be formed in the ferrule 10. The holding member 20 may hold the ferrule 10 using a mechanism other than the guide pin 25.

In addition, in one or more embodiments, the engaged portion 35 is described as a hole (engaged hole 35) that is open to the upper surface or the lower surface of the small-diameter portion 32 and communicates with the through-hole 37, but the configuration of the engaged portion 35 is not limited to this. The engaged hole 35 does not have to penetrate the outer peripheral surface of the small-diameter portion 32 as long as the engaged hole 35 is open to the inner peripheral surface (through-hole 37) of the small-diameter portion 32. Alternatively, the engaged portion 35 does not have to be a hole. As long as the engaging portion 23 and the engaged portion 35 can be engaged with each other as in one or more embodiments, the configuration of the engaged portion 35 (and the engaging portion 23) can be appropriately changed.

In addition, the engaging hole 72 formed in the adapter 70 does not have to penetrate the outer peripheral surface of the adapter 70 as long as the engaging hole 72 is open to the inner peripheral surface of the connector insertion hole 71.

In addition, in one or more embodiments, the configuration of the male connector 1M and the configuration of the female connector 1F are described as the same, but the configuration of the male connector 1M may be different from the configuration of the female connector 1F as long as the male connector 1M can be fixed to the connector insertion hole 82 of the receptacle 3. The configuration of the connector insertion hole 82 of the receptacle 3 may be appropriately changed according to the configuration of the male connector 1M.

In addition, the direction in which the release member 50 is divided is not limited to the second direction Y. The release member 50 may be divided in the first direction X or a direction orthogonal to the central axis O of the optical connector 1 (that is, the radial direction) other than the first direction X and the second direction Y. In addition, the release member 50 does not have to be divided into the first member 50A and the second member 50B. The release member 50 may be a tubular member formed integrally.

In addition, the optical connector 1 does not have to include the release member 50 or the restricting portion 60.

In addition, the position in which the engaging claw 33 is provided and the direction in which the engaging claw 33 is bent can be appropriately changed. In this case, the position of the engaging hole 72 in the adapter 70 can be appropriately changed according to the position and bending direction of the engaging claw 33.

In addition, the rotation direction of the rotating portion 90 with respect to the main body portion 80 can be appropriately changed.

In addition, in one or more embodiments, the rotating portion 90, which is a mechanism for generating a force to press the connectors 1F and 1M against each other (hereinafter referred to as a connection mechanism), is provided in the receptacle 3. However, the connection mechanism may also be provided in the optical connector assembly 2 (the adapter 70). However, in a case where the connection mechanism is provided in the optical connector assembly 2, the size of the optical connector assembly 2 increases, making the optical connector assembly 2 difficult to accommodate, for example, at the towing end. A configuration in which the connection mechanism (rotating portion 90) is provided in the receptacle 3 as in one or more embodiments is also suitable in that the optical connector assembly 2 can be easily reduced in size.

In addition, it is possible to appropriately replace the constituent elements in the above-described embodiments with well-known constituent elements and the above-described embodiments and modification examples may be appropriately combined without departing from the spirit of the present invention.

### REFERENCE SIGNS LIST

100: Optical connecting structure
1: Optical connector
2: Optical connector assembly
3: Receptacle
10: Ferrule
10a: Connection end surface
11: Fiber hole
20: Holding member
23: Engaging portion
30: Spring push
33: Engaging claw
35: Engaged portion (Engaged hole)
40: Biasing member
50: Release member
50A: First member
50B: Second member
60: Restricting portion
70: Adapter
72: Engaging hole
73: Protruding portion
80: Main body portion
90: Rotating portion
93a: Curved surface

1. An optical connector comprising:
a ferrule including a connection end surface having a fiber hole through which an optical fiber is inserted;
a holding member that holds the ferrule;
a spring push; and
a biasing member that biases the ferrule, one end of the biasing member contacting the holding member and the other end of the biasing member contacting the spring push, wherein
the holding member includes an engaging portion, and
the spring push includes an engaged portion that engages the engaging portion.

2. The optical connector according to claim 1, wherein
the holding member further includes an extending portion extending toward the spring push and penetrating the biasing member, and
the engaging portion is disposed on the extending portion.

3. The optical connector according to claim 1, wherein
the engaged portion is a hole, and
at least part of the engaging portion is inserted into the hole to:
prevent the holding member from falling off the spring push due to a biasing force of the biasing member, and
allow the holding member to approach the spring push.

4. The optical connector according to claim 1, further comprising:
a release member that covers at least part of the spring push from an outer side in a radial direction of the optical connector, wherein
the spring push further includes an engaging claw that engages an adapter, and
when the release member is pulled in a rearward direction from the ferrule toward the spring push, the release member bends the engaging claw toward an inner side in the radial direction and releases an engagement between the engaging claw and the adapter.

5. The optical connector according to claim 4, wherein the release member includes:
a first member; and
a second member that is connected to the first member to interpose at least part of the spring push in the radial direction.

6. The optical connector according to claim 4, further comprising:
a restricting portion that restricts the release member from falling off in the rearward direction from the spring push.

7. An optical connector assembly comprising:
optical connectors each of which is the optical connector according to claim 4; and
the adapter into which the optical connectors are inserted, wherein
the adapter includes engaging holes that engage the engaging claw of each of the optical connectors.

8. An optical connecting structure comprising:
the optical connector assembly according to claim 7; and
a receptacle including:
a main body portion; and
a rotating portion that is attached to the main body portion such that the rotating portion switches between a fixed state in which the optical connector assembly is fixed to the main body portion and a non-fixed state in which the optical connector assembly is allowed to be removed from the main body portion by a rotational movement,
the adapter includes a protruding portion that protrudes from an outer peripheral surface of the adapter, and
the rotating portion has a convex curved surface that gradually presses the protruding portion in a forward direction opposite to the rearward direction as the rotating portion switches from the non-fixed state to the fixed state-.
